(19) United States
(12) Patent Application Publication
(10) Pub. No.: US 2014/0258945 A1
(43) Pub. Date: Sep. 11, 2014

(54) INFORMATION PROCESSING APPARATUS AND INFORMATION PROCESSING METHOD

(71) Applicants: TOSHIBA TEC KABUSHIKI KAISHA, Tokyo (JP); KABUSHIKI KAISHA TOSHIBA, Tokyo (JP)

(72) Inventors: Tsunehiro Motegi, Tokyo-to (JP); Mahina Nakamura, Tokyo-to (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/187,872

(22) Filed: Feb. 24, 2014

(30) Foreign Application Priority Data
Mar. 7, 2013 (JP) 2013-045535

(51) Int. Cl. G06F 3/0488

(52) U.S. Cl. CPC G06F 3/0488
USPC 715/863

(57) ABSTRACT

In accordance with one embodiment, an information processing apparatus comprises a box-shaped information display input section configured to be arranged with, on an upper surface thereof, a display screen which is used to display an image and to input information through a touching operation; an approach detection unit configured to detect which side of the information display input section an operator approached; and an input character recognition unit configured to recognize a character input to the display screen on condition that the character is in a right direction seen from a side detected by the approach detection unit.

### CROSS-REFERENCE TO RELATED APPLICATION

This application is based upon and claims the benefit of priority from Japanese Patent Application No. 2013-045535, filed Mar. 7, 2013, the entire contents of which are incorporated herein by reference.

### FIELD

Embodiments described herein relate to an information processing apparatus and an information processing method.

### BACKGROUND

Conventionally, a box-shaped information display input apparatus is known which includes, on an upper surface thereof, a rectangular display screen which is used to display a character, an image and the like. Such an information display input apparatus is convenient when, for example, operators sit at four sides of the apparatus to have a discussion.

However, in a case where characters are displayed in the screen displayed on the information display input apparatus, though it is easy for the operator sitting at one side to read the characters, it is difficult for the operators sitting at other sides to read the displayed characters.

Further, in a case where the display screen is display input screen having a character inputting function in addition to a display function, as there is a right direction for recognizing characters, it is difficult to recognize the characters input in a direction different from the assumed direction.

### BRIEF DESCRIPTION OF THE DRAWINGS

FIG. 1 is a diagram illustrating a constitution example of an information processing apparatus of one embodiment;

FIG. 2 is a diagram illustrating a constitution example of an information display input section of the embodiment shown in FIG. 1;

FIG. 3 is a diagram illustrating a hardware constitution example of the embodiment shown in FIG. 1;

FIG. 4 is a flowchart illustrating operations of the embodiment;

FIG. 5 is a diagram illustrating one example of an instruction displayed on a display screen of the information display input section of the embodiment;

FIG. 6 is a diagram illustrating one example of a displayed document selection screen displayed on the display screen of the information display input section of the embodiment;

FIG. 7 is a diagram illustrating an input example of a print start page to an area displayed on the display screen of the information display input section of the embodiment;

FIG. 8 is a diagram illustrating an input example of a print end page to an area displayed on the display screen of the information display input section of the embodiment;

FIG. 9 is a diagram illustrating an input example of the number of printings to an area displayed on the display screen of the information display input section of the embodiment;

FIG. 10 is a diagram illustrating an example where an operator is inputting the number of printings to an area displayed on the display screen of the information display input section of the embodiment;

FIG. 11 is a diagram illustrating an example where the number of printings has been input by the operator to an area displayed on the display screen of the information display input section of the embodiment;

FIG. 12 is a diagram illustrating a recognition direction of a numeric input in an area displayed on the display screen of the information display input section of the embodiment;

FIG. 13 is a diagram illustrating a recognition direction of characters input, by handwriting, in a booklet displayed on the display screen of the information display input section of the embodiment;

FIG. 14 is a diagram illustrating a gesture for changing a direction of a document displayed on the display screen of the information display input section of the embodiment;

FIG. 15 is a diagram illustrating a direction of the document displayed after the gesture shown in FIG. 14 is performed;

FIG. 16 is a diagram illustrating a display example of other commands; and

FIG. 17 is a diagram illustrating a state where a plurality of persons approached the information processing apparatus of the embodiment.

### DETAILED DESCRIPTION

In accordance with one embodiment, an information processing apparatus comprises a box-shaped information display input section configured to be arranged with, on an upper surface thereof, a display screen which is used to display an image and to input information through a touching operation; an approach detection unit configured to detect which side of the information display input section an operator approached; and an input character recognition unit configured to recognize a character input to the display screen on condition that the character is in a right direction seen from a side detected by the approach detection unit.

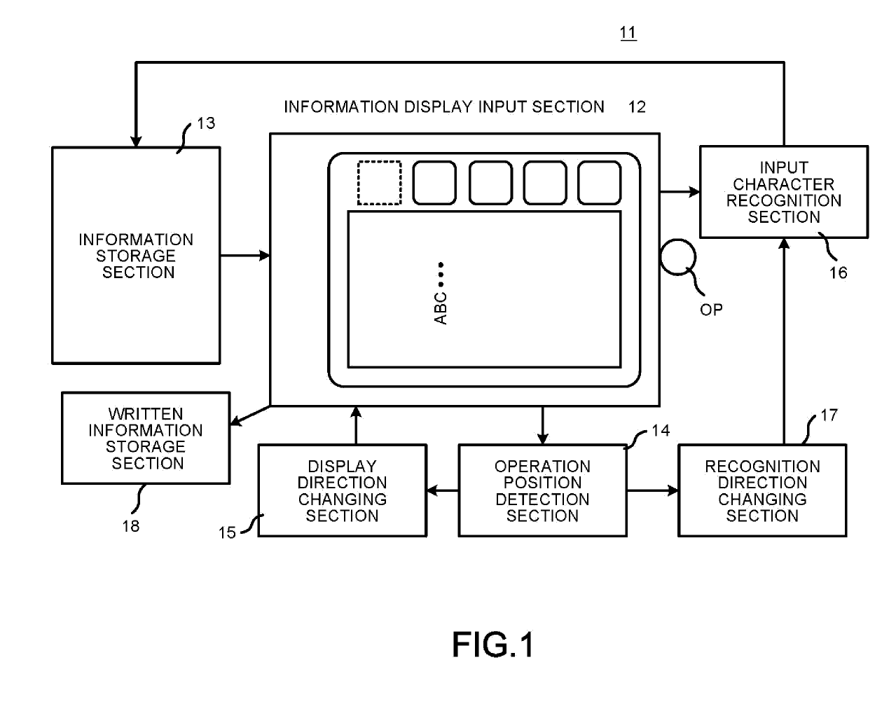

Hereinafter, embodiments of the present invention are described with reference to accompanying drawings. A constitution example of the information processing apparatus of one embodiment is shown in FIG. 1. An information processing apparatus 11 comprises a table-shaped information display input section 12 having a screen on an upper surface thereof through which information can be displayed and input, an information storage section 13 storing information to be displayed on the information display input section 12, an operation position detection section 14 detecting which side of the information display input section 12 an operator OP sat at, a display direction changing section 15 changing a direction of an image or character information displayed on the display screen of the information display input section 12 in response to an operation position detected by the operation position detection section 14, an input character recognition section 16 detecting and recognizing an input of a character written, by handwriting and the like, on the display screen of the information display input section 12, a recognition direction changing section 17 changing a recognition direction of an input character in response to a sitting position of the operator OP detected by the operation position detection section 14, a written information storage section 18 storing additional information written by the operator to the image displayed on the screen of the information display input section 12.

The recognition direction changing section 17 and the input character recognition section 16 change the recognition direction such that the character input to the display screen of the information display input section 12 is in the right direction seen from the side where the position of the operator OP is detected by a human body sensor which will be described later, and then recognize the input character.

The information display input section 12 basically includes a function of displaying input information from the information storage section 13 on the display screen; a function of sending, to the written information storage section 18, the additional information written by the operator OP to the image displayed on the display screen; a function of sending, for example, numeric information input at a given position of the display screen to the input character recognition section 16.

Though information can be input to the display screen using a touch pen, the operator OP generally inputs information by touching the screen with a finger. There is a special area on the display screen, that is, a recognition area 12r, represented by dotted lines, and if the operator writes a character in the area using a finger, the written character is recognized. The recognition area 12r is displayed in such a manner that the operator can distinguish the area from other parts on the screen and is urged to input information in the area.

In the present embodiment, for example, when the page number of the material displayed on the screen of the information display input section 12 is written as a numeric in the recognition area 12r, the input character recognition section recognizes the handwritten numeric, and then the corresponding page is opened. In addition, FIG. 1 shows an example where the operator OP approached the right side of the information display input section 12, and the display screen is displayed facing to the right side.

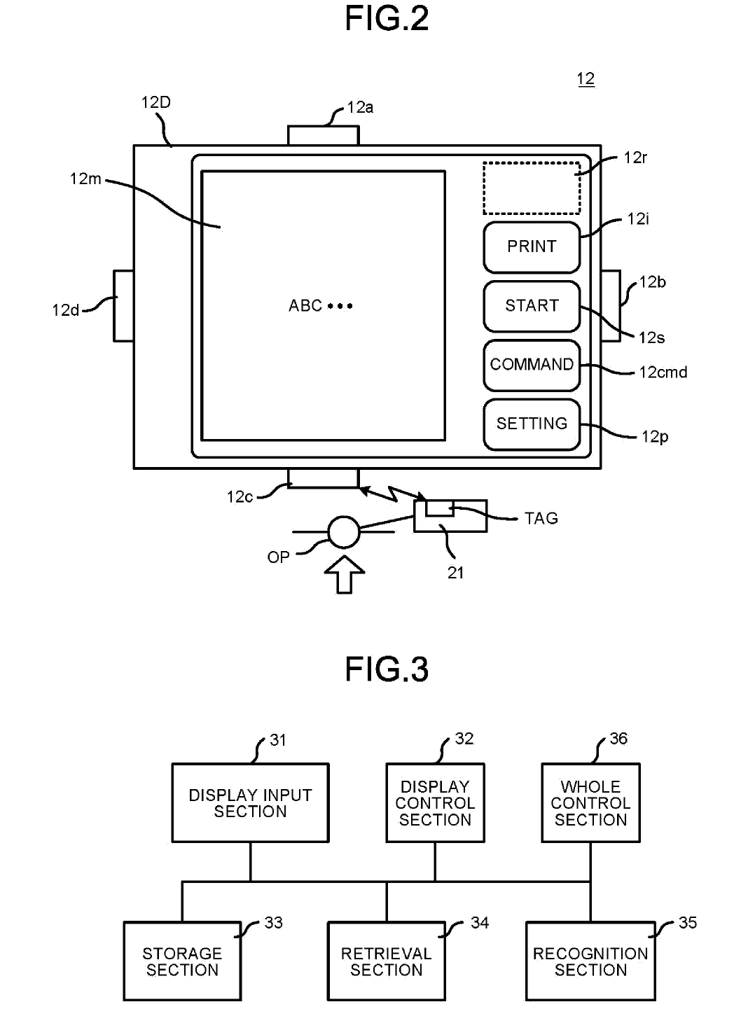

As shown in FIG. 2, the information display input section 12 is, for example, a box-shaped section at each of the four sides of which human body sensors 12a, 12b, 12c and 12d are arranged to sense the approach of a human, and the detection information is input in the operation position detection section 14. Therefore, that which side a person approached is detected by the human body sensors 12a, 12b, 12c and 12d, and then the information indicating which side of the information display input section 12 a person approached is recognized by the operation position detection section 14.

For example, if the human body sensor (12b) arranged at the right side detects an approach of a person, the characters (ABC . . . ) are displayed in a way shown by the display screen in FIG. 1. Further, for example, if the human body sensor 12c detects an approach of a person, as shown in FIG. 2, the characters (ABC . . . ) are displayed facing downward.

As shown in FIG. 2, if the operator OP approaches the information display input section 12 from the lower side thereof, the human body sensor 12 detects the operator and the information display input section 12 is operated. The operator OP carries a certificate 21 attached with a wireless tag in which the ID of the operator is stored, the ID information sent from the wireless tag of the certificate 21 is input in the information display input section 12, and is compared with the ID recorded in a managed permission person list. If the ID is recorded in the permission person list, the operator OP approaching is permitted to access the information display input section 12.

In the display screen 12D of the information display input section 12, for example, an image display area 12m, a recognition area 12r, a print icon 12i, a start icon 12s, a setting icon 12p, a command icon 12cmd and the like are displayed facing the detected direction of the operator OP. If the setting icon 12p is touched, various setting screens are displayed. Further, if the command icon 12cmd is touched, a command which can be instructed is displayed. The command icon, which may not be displayed at a specific position, may also be displayed at a position where the operator puts his hands.

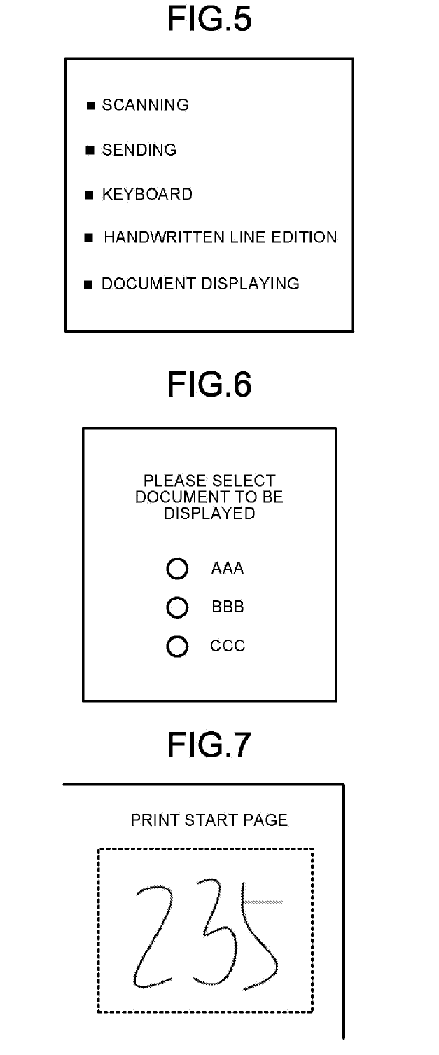

If the command icon 12cmd is touched, various commands are displayed as shown in FIG. 5. The category of the command includes, for example, paper document scanning; cloud, E-mail and FAX sending; keyboard; handwritten line edition; category (display file) reading; and document displaying and the like. For example, if the ‘document displaying’ is touched, as shown in FIG. 6, a list of the document (electronic file) stored in the information storage section 13, for example, ‘AAA’, ‘BBB’ and the like, is displayed. In addition, the document stored in the information storage section 13 may be, for example, a document created with Word, a document created with PowerPoint, or a document that can be displayed with an Acrobat reader and the like, and the document may also include a still image or a moving image. Herein, the still image and the moving image are referred to as a document (electronic file).

If any of the documents is touched and selected, for example, a front cover, of the document, is displayed on the image display area 12m of the display screen 12D of the information display input section 12. The operator OP can write a comment and the like on the image displayed on the image display area 12m. The information written in the image is stored in the written information storage section 18 together with the information of the image in the displayed page.

In a case of carrying out a printing operation, the print icon 12i is separately displayed, and the printing operation is carried out by touching the print icon. The print icon 12i is touched when an operator desires to print the displayed material. If the print icon 12i is touched, for example, in the recognition area 12r, first, a print start page can be input, and when the recognition on the print start page is completed, a print end page can be input. Then, the printing of the designated pages of the material is actually carried out by touching the start icon 12s, and then the printed copy is discharged from a discharge port (not shown).

A hardware constitution example of the information processing apparatus 11 is shown in FIG. 3. The information processing apparatus 11 comprises a display input section 31 displaying an image or icon, a recognition area and the like, a display control section 32 controlling the display of the display section 31, a storage section 33 storing stored information to be displayed and the like, a retrieval section 34 retrieving the information stored in the storage section 33, a recognition section 35 recognizing the information input from the screen of the display input section 31, a whole control section 36 controlling each section mentioned above.

The display input section 31 corresponds to the information display input section 12, and the storage section 33 corresponds to the information storage section 13 and the written information storage section 18. The display control section 32 includes the operation position detection section 14, the display direction changing section 15 and the recognition direction changing section 17 and the like. The recognition section 35 includes the input character recognition section 16. The retrieval section 34 includes the part accessing the information storage section 13 in response to the output from the input character recognition section 16. The adjustment control of the rest sections is carried out by the whole control section 36.

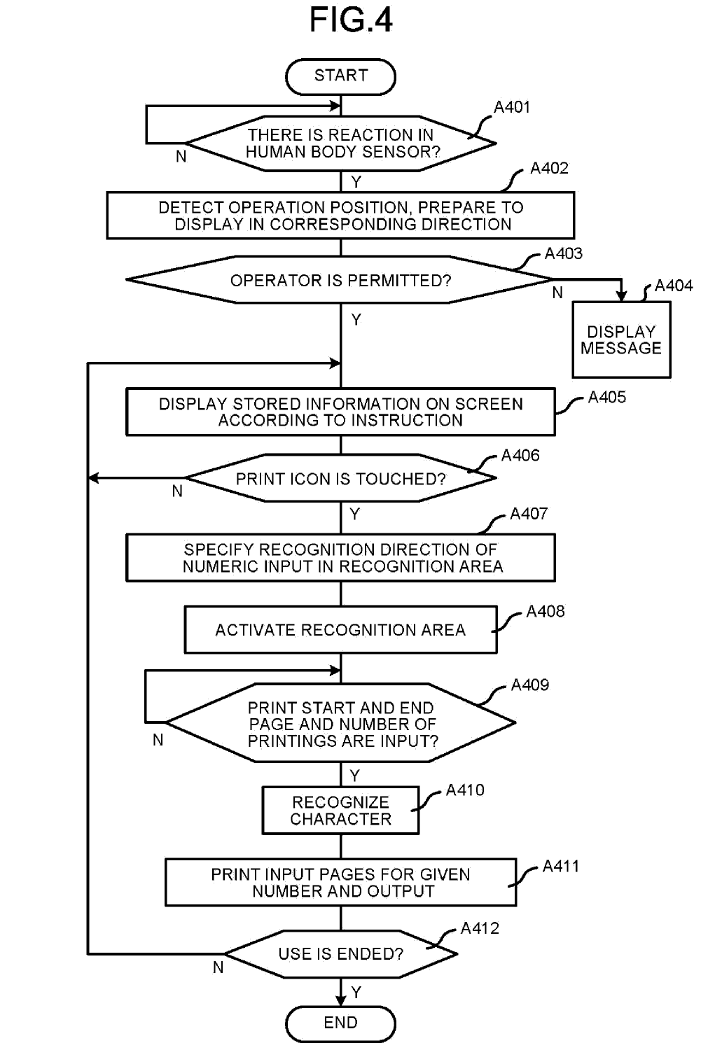

Next, the operations of the present embodiment are described based on the flowchart shown in FIG. 4. First, in ACT A401, it is checked whether or not there is a reaction in any of the human body sensors 12a, 12b, 12c and 12d.

If there is a reaction in any of the human body sensors 12a, 12b, 12c and 12d, the sitting position of the operator can be known according to the arrangement position of the human body sensor having a reaction, and then the display in the direction of the position is prepared.

Next, in ACT A403, the ID of the detected operator OP is read from the wireless tag of the certificate to check whether or not the operator is recorded in the permission person list. If the operator is not recorded in the permission person list (NO in ACT A403), a message of, for example, ‘Sorry, you are not permitted to access the apparatus’, is displayed (ACT A404).

On the other hand, if the operator is recorded in the permission person list, according to an instruction of the operator OP, the information stored in the information storage section 13 is displayed on the display screen 12D of the information display input section 12 in a proper direction for the sitting position of the operator.

For example, if the operator OP is detected by the human body sensor 12c at the lower side of the information display input section 12, the image or print icon 12i, the start icon 12s, the setting icon 12p, the command icon 12cmd and the like are displayed in a direction shown in FIG. 2 (ACT A405).

Herein, the command icon 12cmd is touched, and, for example, the ‘document displaying’ in the commands shown in FIG. 5 is touched and selected. Then, for example, the ‘BBB’ is touched and selected as a document in the screen of FIG. 6 which is displayed immediately the ‘document displaying’ is selected. As a result, the document of ‘BBB’ is displayed on the image display area 12m of the display screen 12D of the information display input section 12.

In this way, in ACT A405, the information display input section 12 displays the content of the document stored in the information storage section 13 based on the instruction of the operator OP.

Next, in ACT A406, it is detected whether or not the operator OP touches the print icon 12i. If the operator OP touches the print icon 12i, in ACT A407, the recognition direction of the numeric input in the recognition area 12r is specified in response to the operation position detected in ACT A402. For example, in a case where the operator OP is detected by the human body sensor 12c, it is assumed that the numeric is written, by handwriting, in a direction from the left to the right in the recognition area 12r, and then the input character recognition section 16 recognizes the input numeric in such a direction.

In ACT A408, the recognition area 12r is activated such that the numeric can be recognized no matter when it is input in the recognition area. Next, in ACT A409, it is checked whether or not the page number of the pages needed to be printed and the number of printings are input.

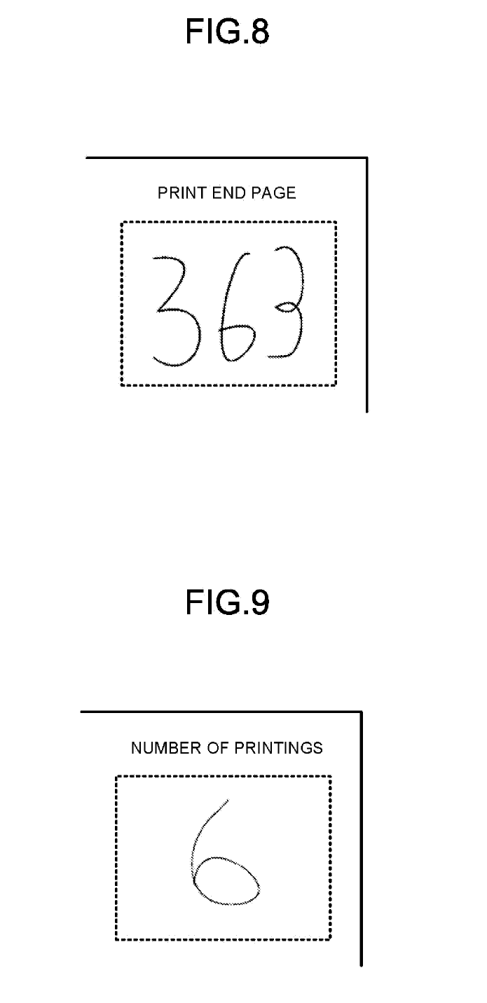

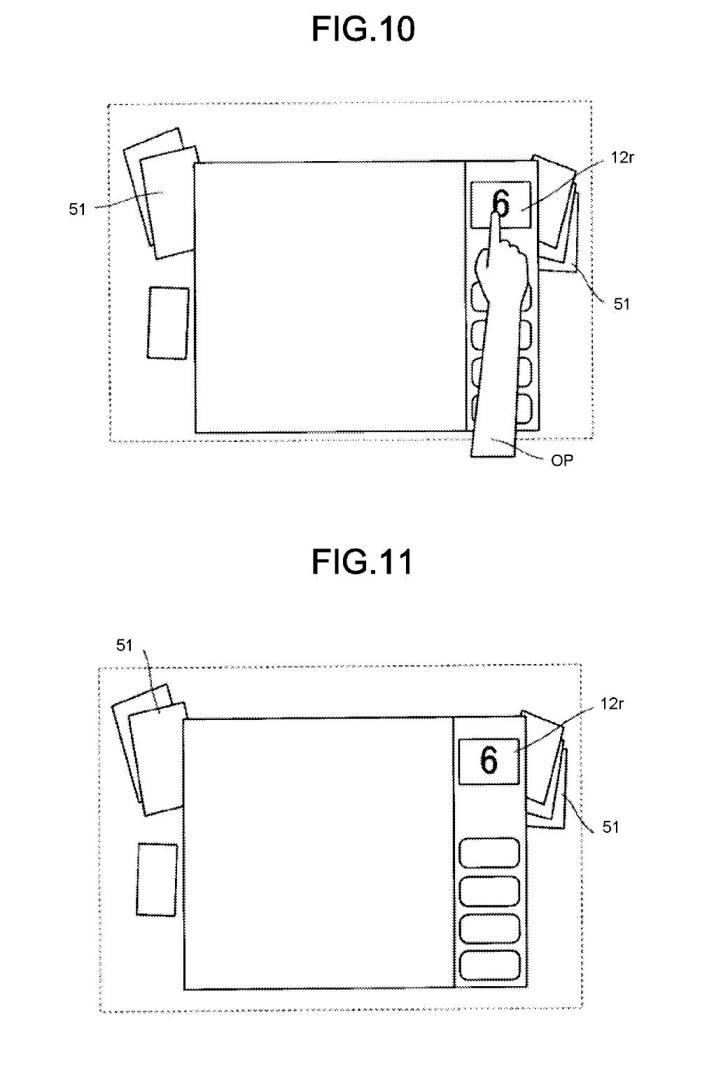

For example, as shown in FIG. 7, the operator OP first writes the print start page (for example ‘235’) in the recognition area 12r, and then as shown in FIG. 8, the operator writes the print end page (for example ‘363’) in the recognition area 12r by handwriting, and next, as shown in FIG. 9, the operator writes the number of printings (for example ‘6’). FIG. 10 illustrates a state where the operator OP is writing the number of printings ‘6’ in the recognition area 12r, and FIG. 11 illustrates a state after the number of printings is written in the recognition area 12r. In FIG. 10 and FIG. 11, behind the file the content of which is actually being viewed, other document files 51 are also displayed such that it can be intuitively and easily known that these files are also stored.

After these inputs are completed, the handwritten numeric is recognized by the input character recognition section 16.

In this way, as the pages needed to be printed and the number of printings are specified, the inputs are completed. In addition, as shown in FIG. 7 to FIG. 9, if that whether the input numeric is to be recognized as the print start page, or as the print end page, or as the number of printings is displayed at, for example, the upper part of the recognition area when the recognition area is activated, the operator OP can easily know what numeric to write.

The information of the print start page, the print end page and the number of printings is sent to the information storage section 13 from the input character recognition section 16, the material from page 235 to page 363 is printed in sextuplicate, and then output from the information display input section 12.

In this way, after the printing of the document is completed, it is checked in ACT A412 whether or not the operator ends the use of the apparatus. In a case of ending the use, the operator touches an end icon (not shown). In a case of continuing the use of the apparatus, the flow returns from ACT A412 to ACT A405 to display, for example, other documents on the information display input section 12 as stated above. At this time, the corresponding page can be opened using the recognition area 12r.

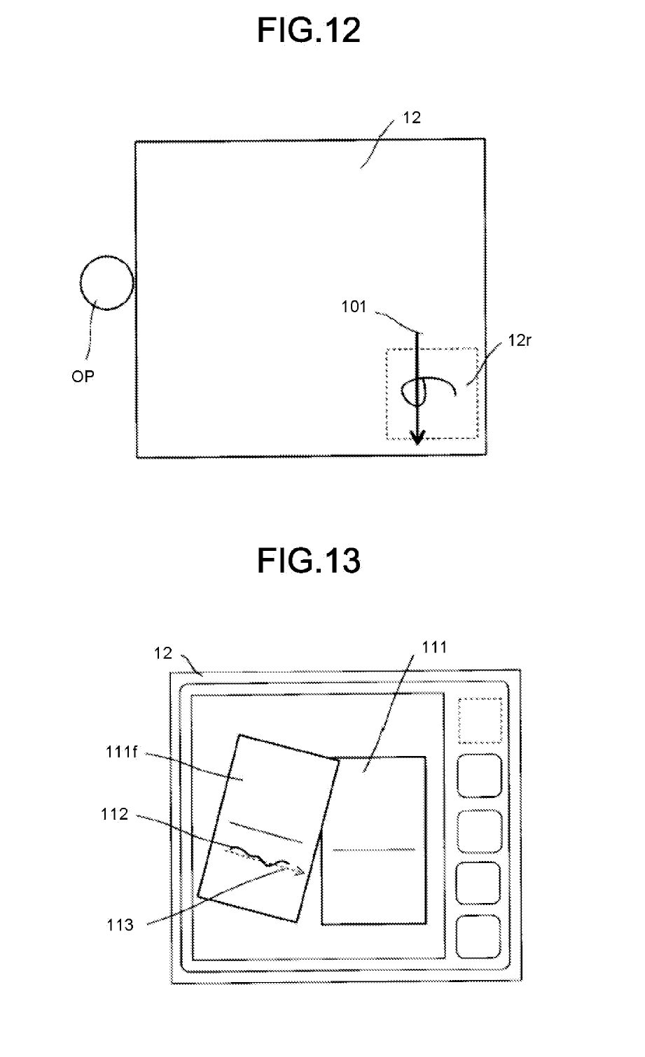

In addition, when the operator OP is detected by, for example, the human body sensor 12d of the information display input section 12, if a numeric ‘6’ is input as the number of printings, the numeric is displayed as shown in FIG. 12. At this time, in the input character recognition section 16, the handwritten numeric ‘6’ is recognized in a direction indicated by an arrow 101.

In the aforementioned embodiment, since only numeric is handled as a handwriting input, there is an advantage that the input character recognition section 16 can recognize the input content through a simple recognition.

In the aforementioned embodiment, in addition to the number of printings, the print start page and the print end page are also input by handwriting. However, it may also be set that only the number of printings is input by handwriting.

In addition, in the aforementioned embodiment, the input character recognition section 16 only recognizes characters input by handwriting in the recognition area 12r. However, the comment and the like handwritten by the operator OP in the display part displayed in the image display area are also recognized by the input character recognition section 16.

Further, in a case where the information to be displayed is a booklet having a plurality of pages, it is preferred that the booklet is actually displayed in an opened state on the display screen of the information display input section 12. FIG. 13 illustrates a state where the booklet is displayed. A booklet 111 is in an opened state. It is assumed in this case that the operator OP recorded something on, for example, a page 111f at the left.

In a case of enabling the input character recognition section 16 to recognize the information handwritten by the operator OP in the display screen, since the left page of the booklet 111 inclines a little, as shown by the number 112, the operator OP handwrites a comment and the like in the inclined state. To cope with such a case, it is preferred to allow inclination in the recognition direction such that the input characters can be recognized even if the character recognition direction of the input character recognition section 16 is inclined a little. Alternatively, if the handwritten character string 112 is continuous, it is preferred that the continuous direction 113 is recognized, and the characters are recognized according to the direction.

Further, as stated above, the information display direction is automatically determined in response to the sitting position of the operator OP, however, it is not limited to this, and the information display direction may also be arbitrarily changed.

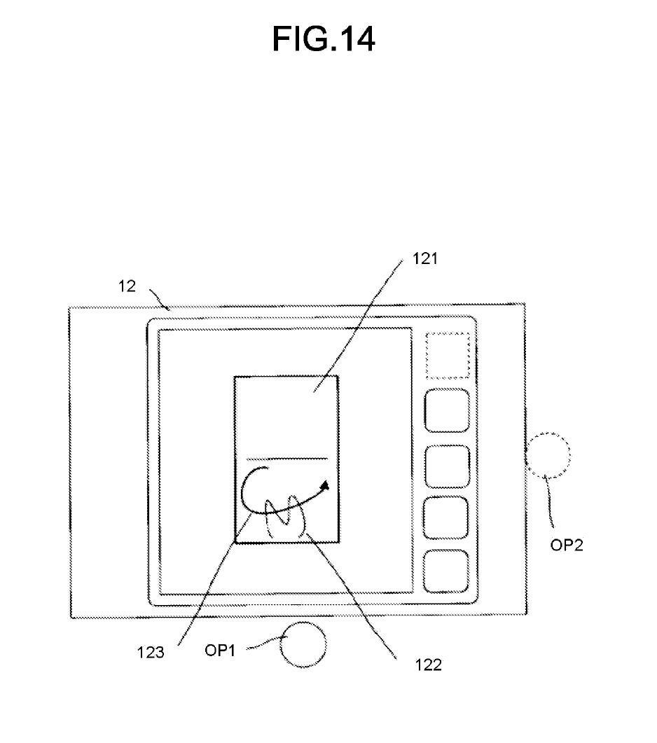

For example, as shown in FIG. 14, an operator OP1 is at the lower side of the figure. At this time, the paper information 121 of the information display input section 12 is displayed facing the direction of the operator OP1. Then, the operator OP1 can show the paper information 121 to, for example, an operator OP2 at the right side thereof.

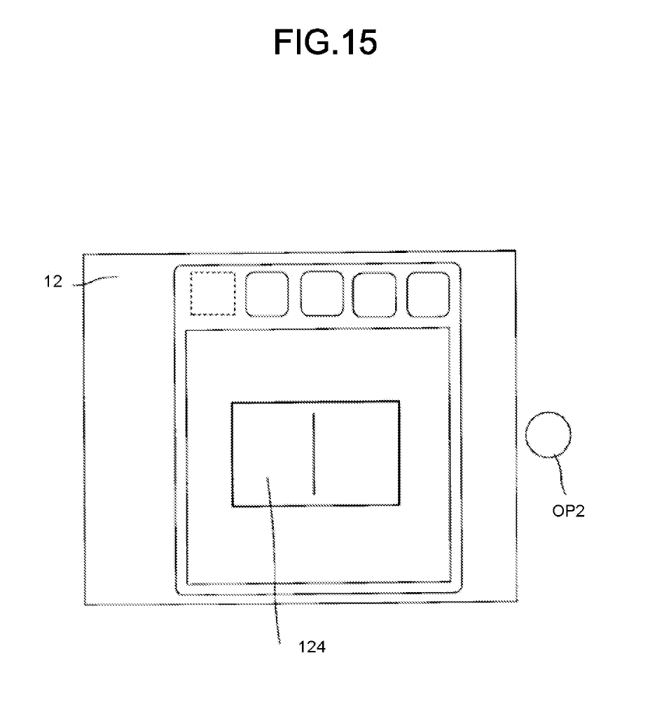

Specifically, the operator OP1 touches the display screen 12D of the information display input section 12 using his two fingers 122, and then carries out an operation of twisting (one kind of gesture) in a direction indicated by an arrow 123 in the touching state. At this time, as shown in FIG. 15, the position of the information display input section 12 is not changed, while the direction of the paper information displayed on the display screen 12D is changed. Of course, it is also possible to change the direction of the displayed paper information 121 merely.

The operation of the operator OP1 on the display screen is detected by, for example, the operation position detection section 14 shown in FIG. 1, and then notified to the display direction changing section 15 and the recognition direction changing section 17.

As stated above, the direction of the information to be displayed can be automatically determined by the human body sensor at first, and then artificially changed.

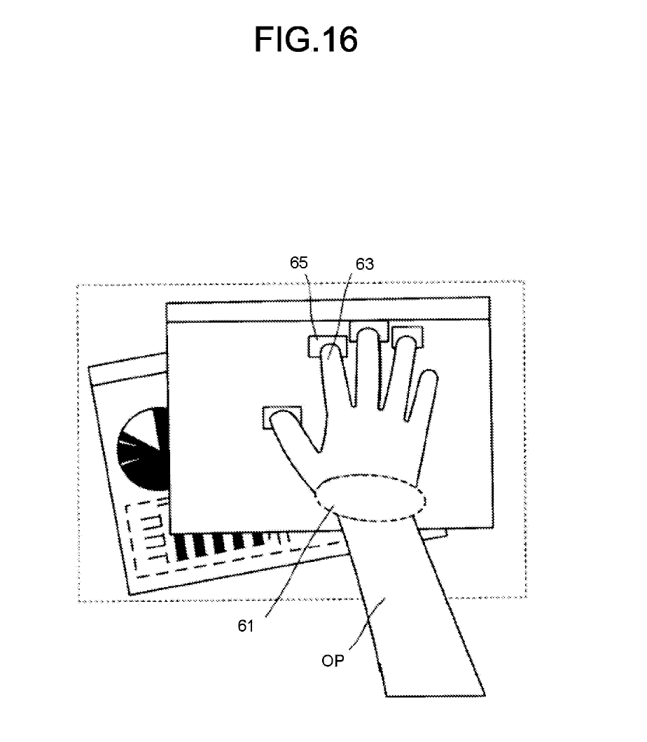

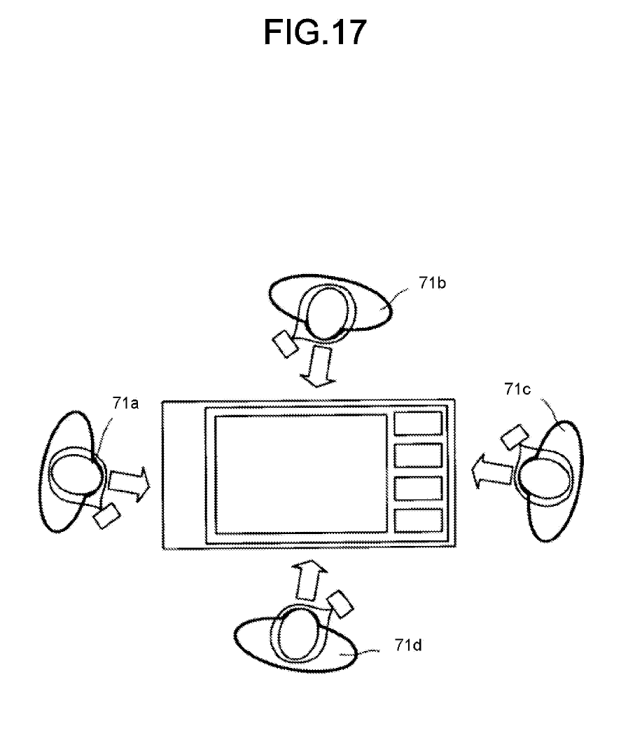

Further, in the aforementioned embodiment, the operation buttons and the like are displayed at the right side of the operator OP all the time. However, as shown in FIG. 16, when the operator OP puts the carpus 61 on the display screen, the position of the carpus 61 is detected, and then a specific command may be displayed at a position of the tip of the finger. For example, a print command 65 is displayed at the position of an index finger 63 in FIG. 16. When desiring to print, the operator can touch the display screen with the index finger 63 to carry out the printing operation, therefore, there is no need for the operator to look for the print button.

In addition, in the aforementioned embodiment, it is based on that only one person (operator) approached the information display input section. However, as shown in FIG. 17, there also exists a case where a plurality of persons (e.g. four: 71a, 71b, 71c, and 71d), each of whom carries a wireless tag, approach the information processing apparatus 11. There also exists a case where the human body sensor at each side detects the approach of a person. In this case, the position of the operator OP can be determined in response to the first human body sensor that detects the approach of a person. The person (e.g. 71d) who is the first to be detected is preferentially regarded as the operator, and the display direction is determined based on the detection.

In addition, the information storage section 13 in the aforementioned embodiment consists of a high-capacity storage device such as a general hard disk drive and the like, and is enabled to store special material used for discussion by a user thereof. In addition, character information such as news and the like, still image, moving image information and the like may also be input and stored from an external device via an internet.

In the aforementioned embodiment, that which position of the information display input section a person approached is detected by the human body sensor arranged at the side of the information display input section. However, that which side a person approached can also be detected by a monitoring camera from upside.

As stated above, in accordance with the aforementioned embodiment, there is provided an information processing apparatus and an information processing method for correctly recognizing a character no matter an operator inputting the character is sitting at which side of a box-shaped information display input section having a display screen on the upper surface thereof.

In the aforementioned embodiment, the command icon, print icon and the like are also displayed on the display screen, however, it is not limited to this, these icons may also be arranged and fixed on the information display input section outside the display screen.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus, comprising:
a box-shaped information display input section configured to be arranged with, on an upper surface thereof, a display screen which is used to display an image and to input information through a touching operation;
an approach detection unit configured to detect which side of the information display input section an operator approached; and
an input character recognition unit configured to recognize a character input to the display screen on condition that the character is in a right direction seen from a side detected by the approach detection unit.

2. The information processing apparatus according to claim 1, wherein
the approach detection unit is a human body sensor arranged at each side of the information display input section.

3. The information processing apparatus according to claim 1, wherein
the input character recognition unit includes:
a recognition direction changing section configured to change a recognition direction of a character input to the display screen such that the character is in a right direction for the side of the information display input section detected by the approach detection unit;
an input character recognition section configured to recognize the character input to the display screen based on the recognition direction changed by the recognition direction changing section.

4. The information processing apparatus according to claim 1, wherein
the right recognition direction for the side detected by the approach detection unit can be changed through a gesture of the operator of touching the display screen.

5. The information processing apparatus according to claim 1, wherein
an area where the number of printings of an image displayed on the display screen can be input is determined at a given position of the display screen.

6. An information processing method, including:
detecting which side of a box-shaped information display input section, which has, on an upper surface thereof, a display screen used to display an image and to input information through a touching operation, an operator approached; and
recognizing a character input in the display screen on condition that the character is in a right direction seen from the detected side.
